(19) United States
(12) Patent Application Publication
(10) Pub. No.: US 2014/0281094 A1
(43) Pub. Date: Sep. 18, 2014

(54) EXTERNAL ACCESS OF INTERNAL SAS TOPOLOGY IN STORAGE SERVER

(71) Applicant: Silicon Graphics International Corp., Fremont, CA (US)

(72) Inventor: Jay Everett Nelson, Superior, CO (US)

(21) Appl. No.: 13/931,782

(22) Filed: Jun. 28, 2013

Related U.S. Application Data
(60) Provisional application No. 61/786,435, filed on Mar. 15, 2013.

(51) Int. Cl. G06F 13/40

(52) U.S. Cl. CPC G06F 13/4068
USPC 710/301

(57) ABSTRACT

The SAS expander PCBA is partitioned to allow SAS lanes to be externalized, allowing for a x4 wide port external access into each of the two primary SAS expander modules and each of the two secondary SAS expander modules. This configuration allows for a single host x8 external HBA connection to tunnel into the storage array by connecting into either the primary or secondary x4 wide ports. A second host may connect to the alternate connection if desired. This configuration may also lend itself to allow up to four hosts to access the internal SAS topology of the Enclosure. This configuration may also lend itself to connecting the primary and secondary SAS expander modules together in applications that require an SAS expander to see more storage device arrays than would normally be confined to a typical SAS expander module.

### CROSS-REFERENCE TO RELATED APPLICATIONS

The present application claims the priority benefit of U.S. provisional application No. 61/786,435, titled “EXTERNAL ACCESS OF INTERNAL SAS TOPOLOGY IN STORAGE SERVER,” filed Mar. 15, 2013, the disclosure of which is incorporated herein by reference.

### BACKGROUND OF THE INVENTION

1. Field of the Invention

The present invention relates to SAS connectors, and more particularly to providing external access to an internal SAS topology.

2. Description of the Related Art

As companies create and process more data, the need for improved data storage systems has increased. The need for better storage systems has pushed the development of storage servers, resulting in compact machines having a lot of circuitry.

Storage servers may typically include several host bus adaptors (HBA) in their circuitry. The HBAs are used to connect the host computer to other devices and components, and provide access to storage devices. There are a fairly limited number of HBA slots available in typical storage servers. With a limited number of HBAs, only a limited number of devices may utilize an HBA slot and have access to the storage devices.

What is needed is an improved SAS topology that provides greater access to the storage device array.

### SUMMARY OF THE CLAIMED INVENTION

The SAS expander PCBA is partitioned to allow SAS lanes to be externalized, allowing for x4 wide port to have external access into each of the two primary SAS expander modules and a x4 wide port to have access into each of the two secondary SAS expander modules. This configuration allows for a single host x8 external HBA connection to tunnel into the storage array by connecting one of the x4 wide ports to the primary external SAS connector and the other x4 wide port to connect to the secondary external SAS connector. In another example up to two hosts may connect to the internal SAS topology using the four x4 mini-sas high density connectors. This configuration may also lend itself to connecting the primary and secondary SAS expander modules together in applications that require a SA expander to see more storage device arrays than would normally be confined to a typical SAS expander module

Unlike prior storage systems that make use of an HBA slot to pass through SAS connections into the array using connectors into the back end SAS topology and connectors for the external cables, the present invention maintains serviceability of server modules in that a server may go down while the backup server has access to the server.

### BRIEF DESCRIPTION OF THE DRAWINGS

FIG. 1 is illustrates a perspective view of SAS expansion circuitry.

FIG. 2 is a block diagram of an SAS topology interconnect.

FIG. 3 is a block diagram of an SAS expander block diagram.

FIG. 4 is a block diagram of a mid plane connector.

### DETAILED DESCRIPTION

The SAS expander PCBA is partitioned to allow SAS lanes to be externalized, allowing for x wide port external access into each of the two primary SAS expander modules and each of the two secondary SAS expander modules. This configuration allows for a single host x8 external HBA connection to tunnel into the storage array by connecting into either the primary or secondary x4 wide ports. A second host may connect to the alternate connection if desired. This configuration may also lend itself to connecting the primary and secondary SAS expander modules together in applications that require an SAS expander to see more storage device arrays than would normally be confined to a typical SAS expander module.

Unlike prior storage systems that make use of an HBA slot to pass through SAS connections into the array using connectors into the back end SAS topology and connectors for the external cables, the present invention maintains serviceability of server modules in that a server may go down while the backup server has access to the server.

FIG. 1 is illustrates a perspective view of SAS expansion circuitry. In the embodiment shown, the SAS expansion circuitry includes four SAS expander modules 110. The modules may be configured as two primary modules and two secondary modules.

FIG. 2 is a block diagram of an SAS topology interconnect. The SAS topology interconnect includes SAS expanders 210, 212, 214, and 216 which connect to a mid plane as well as connectors. SAS expanders 210 and 212 connect with the primary connection lines of connects within the SAS interconnect while SAS expanders 214 and 216 connect with the secondary connection lines of the connectors. Each of SAS expanders 210-216 is also connected to the mid plane—which is connected to two compute engines.

FIG. 3 is a block diagram of an SAS expander block diagram. The block diagram of the SAS expander includes port expander 310, which may be implemented as a programmable system on a chip or other circuitry. Connected to the Port Expander module 310 are SAS connections, slot address signals and other signals, EEPROM, SRAM, FLASH, several ports and cable connections, and other components.

The SAS Expander module may have several features. It may be hot-pluggable in that it may be inserted without disturbing ongoing IO operations in an active enclosure and no physical damage to the SAS expander module or any other enclosure component occur. The SAS expander may have LEDs for providing OK, fault and other information. The expander may have 48 SAS lanes, SGPIO which controls OK, Fault and OK to Service LED's on the drives the SASEXP module services. The SAS expander may implement an SMBUS which may serve as a channel for the service processor in addition to the Ethernet back-bone that the SASEXP uses to communicate to the other SASEXP modules in the Enclosure and the Service Processor. The SAS Enclosure Processor interface allows remote debugging of the Expander on board the SAS expander.

A Volt/Temp Monitor may monitor on-board voltages and temperatures. The SAS expander may also include a CPU Port as an alternate port into the internal registers of the Expander, a debug RS232 connector for access to debug messages from the Kernel running in the Expanders ARM core, a debug RS232 connector for access to command line interface, an EEPROM that stores configuration data associated with the SASEXP module such as the UUID, a low level reset signal to reset the entire module, and other features.

FIG. 4 is a block diagram of a mid plane connector. The mid plane connector of FIG. 4 is a nearly passive PCBA mounted horizontally in the bottom of the Enclosure allowing storage device modules to plug in horizontally and Control/Power PCBA's to plug in vertically. The mid plane allows for supporting cards such as storage device cards, multiple SAS expander PCBAs, service processor, and power modules.

The mid plane may also support fan connectors with PWM fan speed control and fan tachometer monitoring capabilities. The active components populated on the mid plane must be kept at a minimum and follow the requirements previously stated for no single point of failure. These components may include configuration EEPROM used to store FRU data for the mid plane PCBA and interface logic such as Opto-isolators.

All 12V current for the hard drives flows through the mid plane from the 12V power connector to each of the nine possible storage connectors. All 5V current for the hard drives flows through the mid plane from the PWRMOD Point of Load power converters to each of the nine possible storage connectors.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. An SAS expander circuit, comprising:
a printed circuit board assembly (PCBA) including a plurality of SAS lanes, the SAS lanes providing external access to at least one primary module and at least one secondary module;
circuitry for connecting the primary module and the secondary module to an array of storage devices within a storage server.

2. The circuit of claim 1, wherein the PCBA is communicatively coupled to a Midplane PCBA.

3. The circuit of claim 1, wherein the PCBA is not communicatively coupled to a host bus adaptor.

4. The circuit of claim 1, wherein the external access is through an SAS cable connection.

5. The circuit of claim 1, wherein the circuit includes two primary modules and two secondary modules.

6. The circuit of claim 1, wherein the circuit can be coupled to a storage server circuitry during operation of the server without affecting I/O operations of the server.

7. The circuit of claim 1, further comprising a plurality of LEDS, wherein the state of the LEDs indicates fault information for the circuit.

8. The circuit of claim 1, further comprising an enclosure processor interface which allows remote debugging of the circuit.

9. The circuit of claim 1, wherein the circuit can be coupled to one or more fan connectors.
